(19) United States
(12) Patent Application Publication
(10) Pub. No.: US 2017/0185156 A1
(43) Pub. Date: Jun. 29, 2017

(54) HAND TRACKING FOR USER INTERFACE OPERATION AT-A-DISTANCE

(71) Applicant: Microsoft Technology Licensing, LLC, Redmond, WA (US)

(72) Inventors: Jamie Daniel Joseph SHOTTON, Cambridge (GB); Andrew William FITZGIBBON, Cambridge (GB); Jonathan James TAYLOR, London (GB); Richard Malcolm BANKS, Egham (GB); David SWEENEY, London (GB); Robert CORISH, London (GB); Abigail Jane SELLEN, Cambridge (GB); Eduardo Alberto SOTO, Ontario (CA); Arran Haig TOPALIAN, London (GB); Benjamin LUFF, Dundee (GB)

(21) Appl. No.: 14/982,818

(22) Filed: Dec. 29, 2015

(51) Int. Cl. G06F 3/01; G06F 3/0481; G06T 7/00

(52) U.S. Cl. CPC G06F 3/017; G06F 3/011; G06T 7/0046; G06F 3/04812; G06F 2203/04808

(57) ABSTRACT

A user interface comprises a display controller configured to render graphical data on a display, and a memory configured to receive captured sensor data depicting at least one hand of a user operating the user interface without touching the user interface. A tracker is configured to compute, from the captured sensor data, values of pose parameters of a three dimensional model of the hand, the pose parameters comprising position and orientation of each of a plurality of joints of the hand. A processor is configured to compute at least one position on the display from the pose parameters and to update the graphical data on the basis of the position.

### BACKGROUND

Existing user interfaces are typically difficult to operate at a distance. For example, touch screens and other touch interfaces involve a user being close enough to the user interface to be able to physically swipe and touch a touch sensitive display. Mouse based computer interfaces involve a user being close enough to the mouse to be able to operate it. This means that the user is unable to operate the interface when he or she is unable to touch the touch sensitive display or computer mouse, for example, because the display or mouse is too far away, because the user is wearing gloves or is occupied in a task such as cooking and has food or other material on her fingers.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A user interface comprises a display controller configured to render graphical data on a display, and a memory configured to receive captured sensor data depicting at least one hand of a user operating the user interface without touching the user interface. A tracker is configured to compute, from the captured sensor data, values of pose parameters of a three dimensional model of the hand, the pose parameters comprising position and orientation of each of a plurality of joints of the hand. A processor is configured to compute at least one position on the display from the pose parameters and to update the graphical data on the basis of the position.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a user operating a user interface at a distance by using her hand to point as an absolute pointing device;

FIG. 2 shows a user operating a user interface at a distance by using her hand to point as a relative pointing device;

FIG. 3 shows a hand in an example clicking pose;

FIG. 4 shows a hand in an example pointing pose;

FIG. 5 is a schematic diagram of a touch-less user interface which takes input from a tracker;

FIG. 6 is a flow diagram of a method of operation at a tracker and touch-less user interface such as those of FIG. 5;

FIG. 7 is a flow diagram of a method at the tracker of FIG. 5;

FIG. 8 is a graph of performance of a tracker;

FIG. 9 is a flow diagram of a method of shape calibration at a tracker such as that of FIG. 5;

FIG. 10 illustrates an exemplary computing-based device in which embodiments of a user interface are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of operations for constructing and operating the example. However, the same or equivalent functions and sequences may be accomplished by different examples.

An improved user interface is described which enables a user to operate the interface without the need to touch any physical component of the interface such as a touch sensitive display screen, a stylus, a computer mouse, a light pen, or other physical component. The user is able to operate the interface by making fine grained finger movements, for example, as if operating a touch sensitive interface or as if using a computer mouse. This brings increased usability because the user is not required to hold his or her arm for a sustained length of time in a particular position (such as perpendicular to the body) and is able to assume a natural position when operating the user interface. The user does not need to hold his or her arm in a position that is difficult to maintain. Because fine-grained finger movements are used, while at the same time being able to rest or support the arm, the operation is not tiring for the user. Using fine-grained finger movements to operate a user interface enables some transfer of a user's existing skills of being in the world. The finger movements are used either as absolute or relative input to the user interface. For example, touch screen input is absolute input where there is a direct relationship between the touch screen location and a location specified on a graphical display. For example, computer mouse input is typically relative input where there is no such direct relationship. In the context of the present technology, absolute input to the user interface comprises pointing directly at the user interface element to be selected. In this situation, as the user is further from the display (or the display becomes smaller), the range of motion of the finger for absolute pointing becomes smaller. In the case of absolute pointing there is a mapping between the pose parameters and the selected screen/display location, where the mapping can be linear, linear with a constant scale factor applied (gearing), or non-linear.

In the context of the present technology, there are various different types of relative input to the user interface. In these cases there is no direction relationship between the pose parameters and the selected screen/display location. Examples include but are not limited to: hand-relative input, relative velocity input, and relative position input. These are now described in more detail.

In the case of hand-relative input, the position and orientation of a finger relative to the hand is used to control input to the user interface. For example, if a finger of a hand is pointing “straight” (such as in a direction parallel to a longitudinal axis of the palm of the hand) then the cursor or other selection area on the display does not move. If the finger then moves relative to the longitudinal axis the cursor (or other selection area) on the display moves in a corresponding manner. Gearing is optionally applied so that the amount of movement of the finger is a multiple of the amount of movement of the cursor. In the case of hand-relative input, a processor computes the position on the display according hand-relative input, by taking into account position and orientation of a digit relative to the hand.

In the case of relative velocity input, the finger position (such as relative to the longitudinal axis of the palm of the hand) defines the velocity of the cursor on the screen. For example, when the finger is parallel to the longitudinal axis of the palm of the hand the cursor is stationary. For example, when the finger is stationary but pointing slightly to the right the cursor slowly moves to the right. In the case of relative velocity input a processor computes the position on the display by using position and orientation of a digit relative to the hand to define the velocity of a cursor on the display.

In the case of relative position, the position of a digit relative to another object is used to control the cursor position. For example, where a finger is touching a table top and motion of the finger on the table top drives motion of the cursor. When the finger is lifted away from the table top the cursor remains static. In the case of relative position input, a processor computes the position on the display by using the position of a digit relative to another object to control position of a cursor on the display.

The ability to operate the user interface through fine grained finger movements is achieved by capturing sensor data depicting the user's hand. Pose parameters are tracked from the captured sensor data, including position and orientation of a plurality of joints of the hand. In some examples the tracker uses a three dimensional (3D) model of the hand which has shape parameters that are calibrated to the particular individual user's hand. This gives very accurate tracking. In some examples the tracker compute values of the pose parameters by calculating an optimization to fit a model of a hand to data related to the captured sensor data, where variables representing correspondences between the data and the model are included in the optimization jointly with the pose parameters. Using this optimization gives high levels of accuracy.

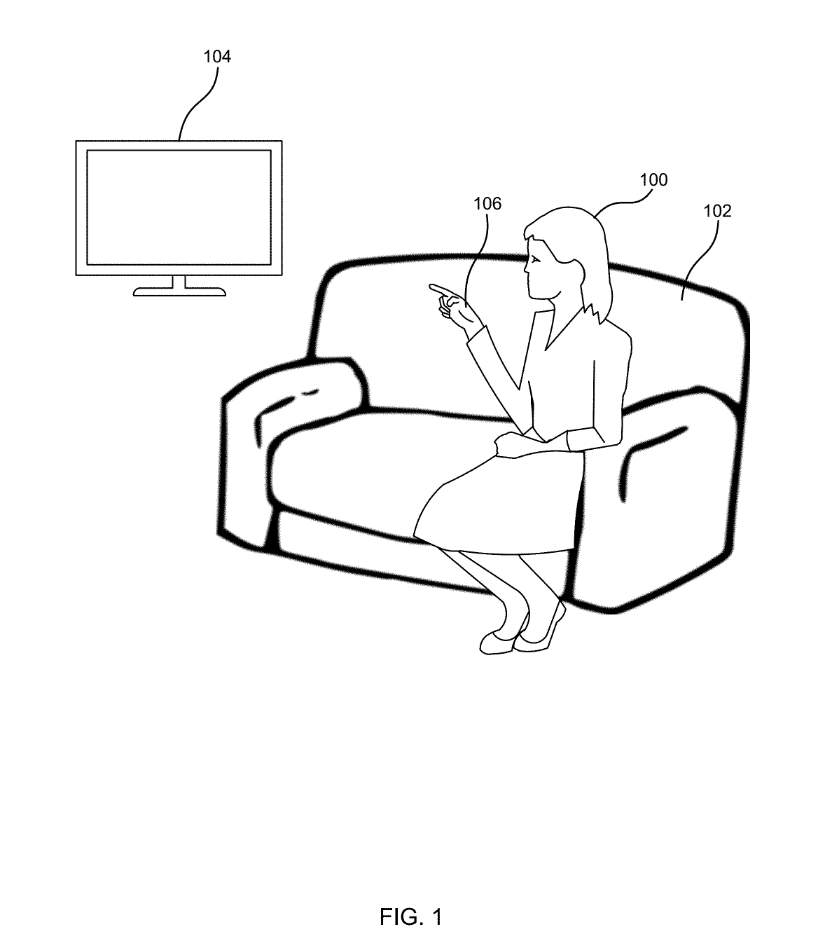

FIG. 1 shows a user 100 operating a user interface at a distance by using her hand 106 to point as an absolute pointing device. In this example the user is sitting on a sofa 102 and is able to operate the user interface whilst her upper arm is resting against her torso. Her forearm is raised in a natural manner which is not tiring. She is able to make fine grained finger movements to adjust the position of a cursor on a screen 104 which is a few meters away from the sofa.

A capture device is mounted on the screen 104 and captures sensor data depicting the user's hand 106 and its environment. The capture device is a depth camera, a color camera, a video camera, a scanning device, or other capture device. In this example the capture device is room-mounted but this is not essential. The capture device is head mounted or body worn in some examples. More than one capture device is used in some examples.

The captured sensor data is input to a tracker (described in more detail below) which computes pose parameters of the hand 106 including position and orientation of a plurality of joints of the hand. The pose parameters are used to update graphical data on the screen 104 such as a cursor or other graphical elements. Optionally the tracker computes shape parameters of the hand and uses these to update graphical data on the screen 104 such as the cursor or other graphical elements where graphical elements include text, video, images, or other graphical elements.

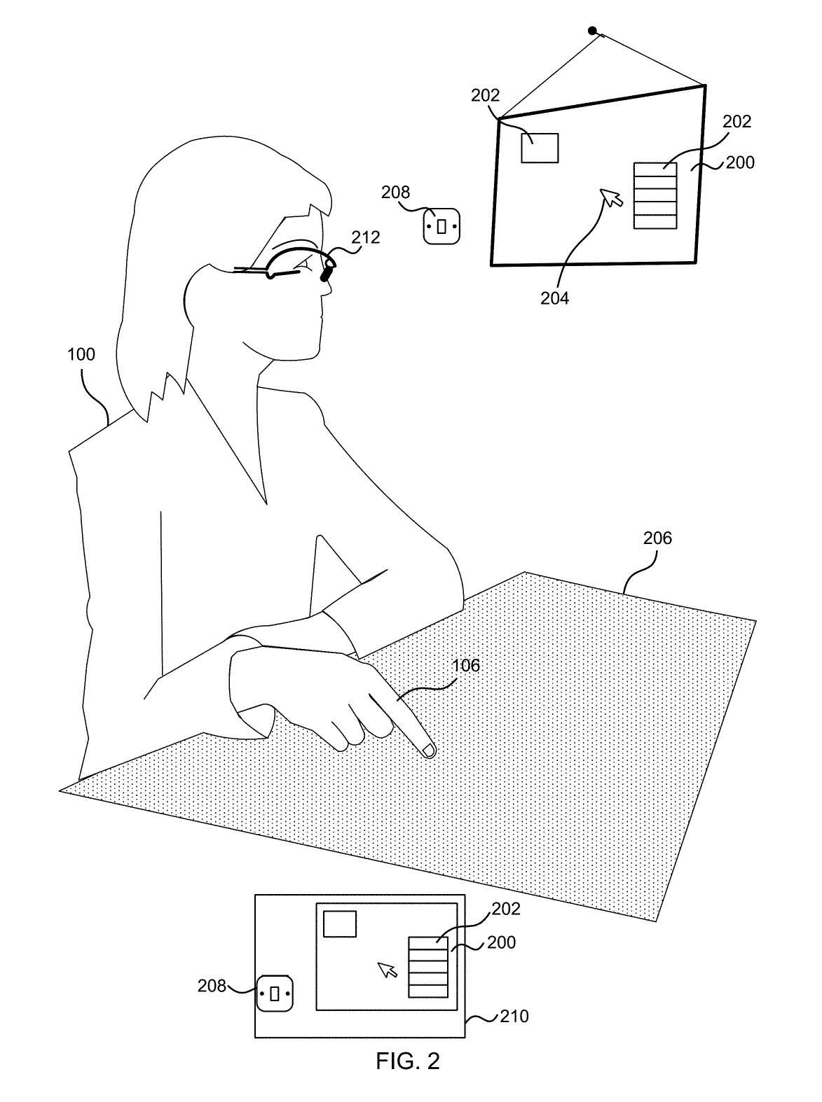

FIG. 2 shows a user 100 operating a user interface at a distance by using her hand 106 to point as a relative pointing device. The user's is wearing augmented reality glasses 212 which enable the user to see graphical elements 202, 204 of the user interface overlaid on a real notice board 200 in her kitchen. One of the graphical elements 204 is a cursor which the user is moving using her finger 106 as a relative pointing device.

A capture device in the augmented reality glasses 212 captures sensor data depicting the user's hand 106 and its environment which includes a kitchen table 206. The sensor data is processed by a tracker which tracks the position of the kitchen table and also tracks the pose parameters of the hand 106. Using the tracked data a processor computes relative pointing data (of the hand relative to the table) and uses that to control the location of the cursor 204. In this example the user is not touching the kitchen table 206. However, it is also possible for the user to touch the kitchen table so as to receive haptic feedback about her finger movements. In this example the user is pointing with a single finger. However, it is also possible for the user to make movements with two or more digits of her hand (as if she were operating a multi-touch sensitive screen). The pose parameters include position and orientation of the digits and this is used to control the augmented reality interface, in a similar manner as for a multi-touch sensitive screen but using a relative rather than an absolute mapping between the pose parameters and the control of the augmented reality display.

The lower part of FIG. 2 shows a view from one eye of the user. It includes a light switch 208 which is in the real kitchen, and the real kitchen notice board 200. The view also includes virtual reality graphical items 202 and 204.

The user interface renders graphical data to a display which is a physical display such as the screen in FIG. 1, an augmented reality display such as in FIG. 2, a virtual reality display, or other display. In the case of a virtual reality display the user is wearing a headset which prevents her from seeing her real environment.

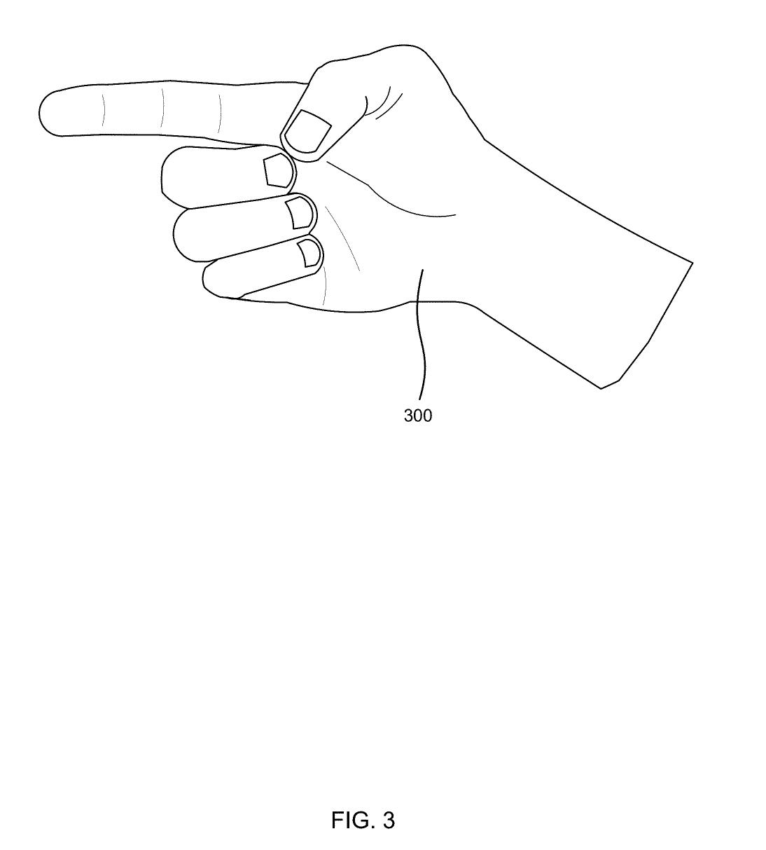

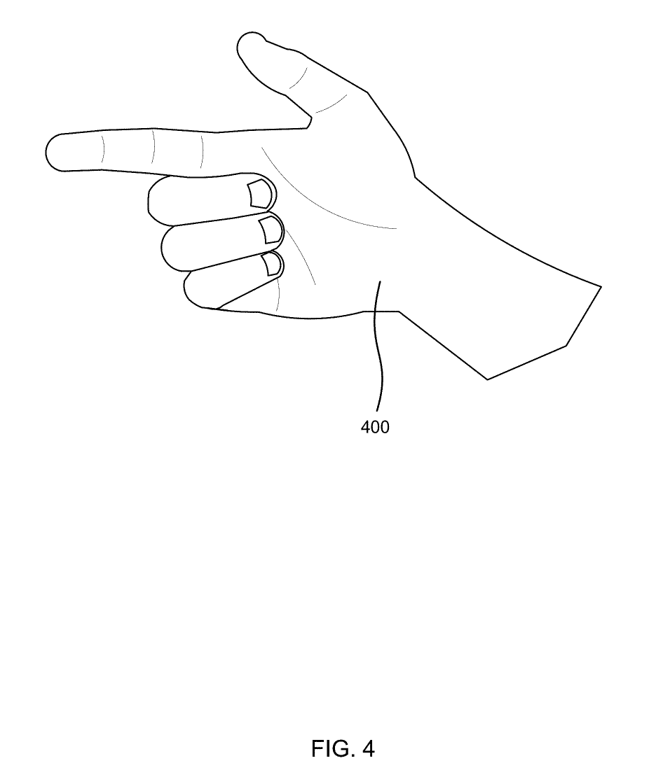

FIG. 3 shows a hand in an example clicking pose 300. This is an example of a pose which is designated as indicating a click, that is an instruction from a user to make a selection. FIG. 4 shows a hand in an example pointing pose 400. This is an example of a pose which is designated as indicating that the user is pointing.

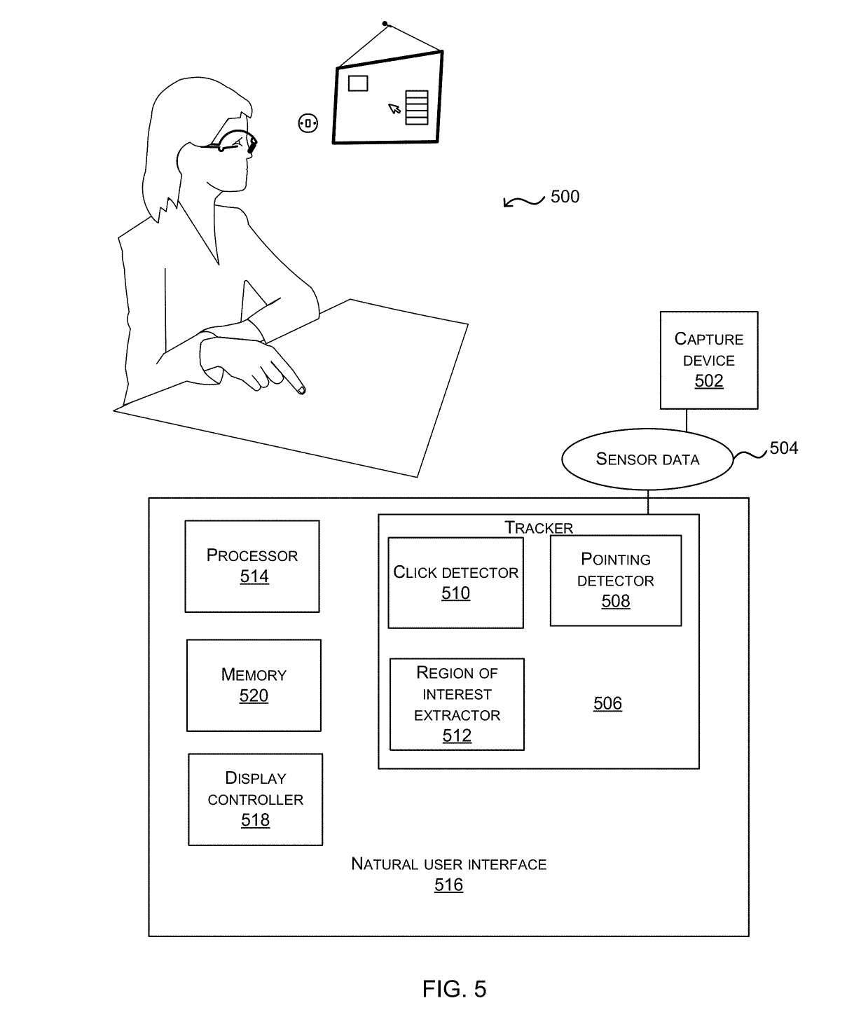

FIG. 5 is a schematic diagram of a touch-less user interface 516 which takes input from a tracker 506. In some examples, the user interface 516 is operated in other manners in addition to the touch-less operation (for example, using a mouse, using a touch sensitive display, using a stylus). In the example of FIG. 5 the tracker is integral with the user interface although this is not essential. The tracker and the user interface are at separate computing entities in some examples and are able to communicate with one another over a wired or wireless communications link.

A capture device 502, as mentioned above, captures sensor data 504 depicting a user's hand and its environment 500. The sensor data is input to the user interface 516 and/or tracker 506 over a wired or wireless connection. In some examples there is more than one capture device. In some examples captured sensor data 504 is sent to the user interface 516 and/or tracker 506 over a communications network.

The tracker has a pointing detector 508, a click detector 510 and a region of interest extractor 512. The tracker is computer implemented using any combination of software, hardware, firmware and comprises a processor and a memory. The tracker computes pose parameters and pointing/click data which are available to the user interface 516. In some examples the tracker sends the pose parameters and pointing/click data to the user interface over a communications network.

The pointing detector 508 is technology configured to detect whether the user is pointing or not. In some examples it comprises trained machine learning technology which has been trained using sensor data labeled as depicting pointing hands or non-pointing hands. In some examples it comprises a gesture detector which uses the pose parameters 514 and information about pose parameters of one or more poses which are designated as being pointing poses (such as that of FIG. 4).

The click detector 510 is technology configured to detect whether the user is making a hand pose which indicates clicking, or not. In some examples it comprises trained machine learning technology which has been trained using sensor data labeled as depicting hands making a click input or not. In some examples it comprises a gesture detector which uses the pose parameters 514 and information about pose parameters of one or more poses which are designated as being pointing click poses (such as that of FIG. 3).

The click detector 510 and the pointing detector 508 are integral in some examples.

The region of interest extractor 512 comprises trained machine learning technology which acts to extract one or more regions of interest from the captured sensor data. A region of interest is part of the captured sensor data which is likely to depict the user's hand rather than the environment or other objects in the scene.

The tracker 506 uses the region of interest to compute values of the pose parameters 516. The tracker uses tracking technology whereby the pose parameters are computed by fitting the region of interest sensor data to a 3D model of a hand. In some examples the 3D model is a mesh model. In some examples the 3D model is a rigged smooth-surface model. More detail about the tracker is given later in this document.

The user interface 516 has a memory 520 which stores pose parameters and pointing/click data, and is able to store captured sensor data 504 in some examples. The user interface 516 has a display controller 518 which renders content to a display such as a virtual reality headset display, a personal computer screen, an augmented reality headset display, a wearable computing device display, a projector, or any other type of display. For example, the display controller 518 is a graphics card, a computer graphics renderer, or other type of display control equipment.

In some examples, the functionality of the tracker and user interface is performed, at least in part, by one or more hardware logic components. For example, and without limitation, illustrative types of hardware logic components are used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

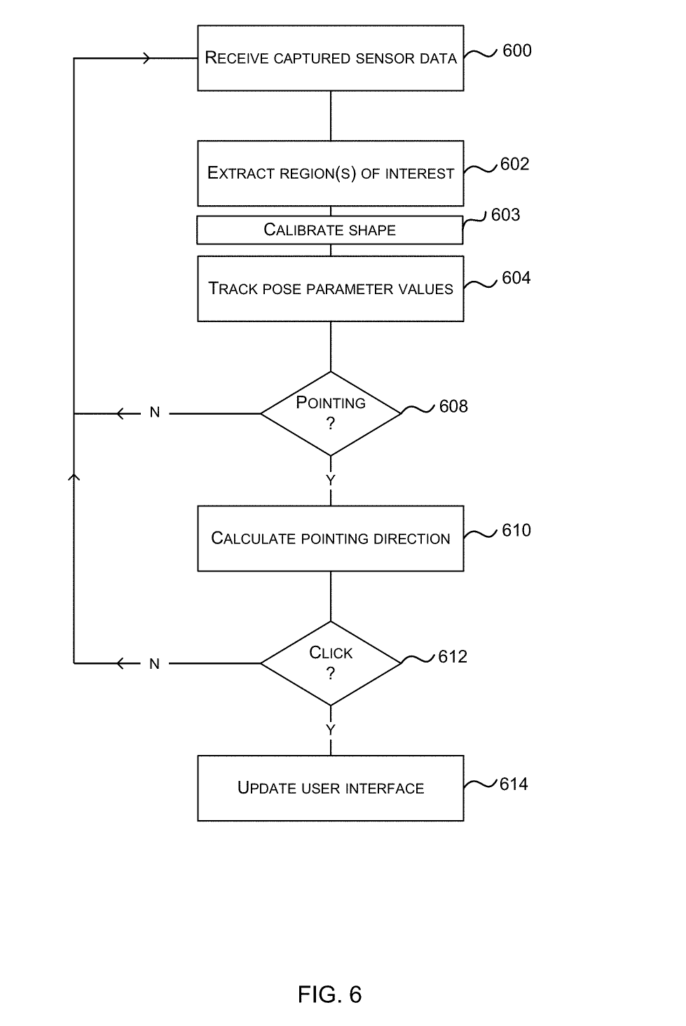

FIG. 6 is a flow diagram of a method of operation at a tracker and touch-less user interface such as those of FIG. 5. Captured sensor data is received 600 at the tracker and one or more regions of interest are extracted 602 one for each hand depicted in the sensor data. For example, if there are multiple users there are potentially several hands depicted in the sensor data.

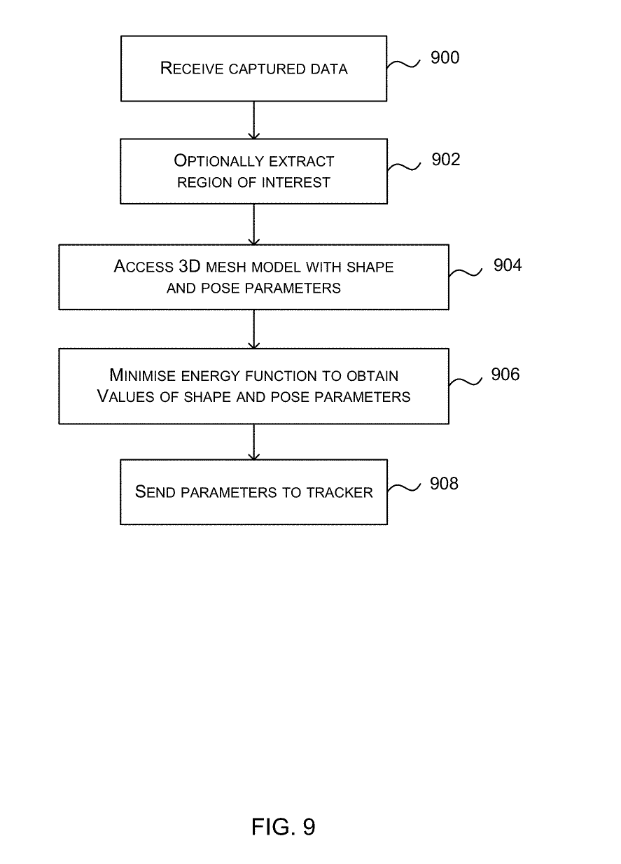

In some examples the tracker calibrates 603 the shape of one or more of the depicted hands. An example of a shape calibration process is described below with reference to FIG. 9. However, the shape calibration operation 603 is optional and good working results are achieved without this operation.

For an individual region of interest, the tracker tracks pose parameter values 604 of a 3D model of a hand. The 3D model is a polygon mesh model or a rigged smooth-surface model in some examples. Other types of 3D model are used in some examples. The pose parameter values comprise positions and orientations of a plurality of joints of the hand. In the case that shape calibration has been done the 3D model of the hand has shape parameter values which are set using the shape calibration results. More detail about how the tracker computes the pose parameter values is given below.

The pose parameter values are used to compute at least one position on a display associated with the user interface. For example a screen such as screen 104 in FIG. 1, an augmented reality display as in FIG. 2, a virtual reality display or other display. In some examples (such as absolute pointing) the computation comprises a direct relationship between at least some of the pose parameter values and the position on the display. In some examples (such as relative pointing) there is no direct relationship between the pose parameter values and the position on the display. In the case that the user is operating the touch-less user interface in a similar manner as for a multi-touch sensitive surface, the pose parameter values of the hand are used to compute a plurality of positions on the display.

In some examples, the tracker also tracks the position and optionally the orientation of one or more surfaces or objects in the environment. For example, a region of interest sometimes includes surfaces or objects in the environment around the hand. In order to track the surfaces or objects in the environment the tracker, in some examples, computes depth values of image elements depicting the surfaces or objects. In some examples the tracker carries out scene reconstruction to reconstruct a representation of the surfaces or objects in the environment around the hand.

In the case that the tracker is used to implement a relative pointing type of user input, the tracker monitors relative differences between tracked pose parameters of the hand and tracked position of the surface or objects in the environment around the hand. For example, in the situation illustrated in FIG. 2, the tracker monitors relative differences between tracked pose parameters of the hand and the tracked position of the kitchen table.

In some examples the pointing detector 508 operates as described above to determine whether the user is pointing or not. If the user is not pointing then the process moves to receiving more captured sensor data at operation 600. If the user is pointing then a pointing direction is calculated 610. This comprises computing a vector between a knuckle joint and a fingertip of a digit connected to the knuckle joint. The position and orientation of the knuckle joint is known from the pose parameters. The position and orientation of the finger tip is known from the 3D model of the hand (such as the 3D mesh model or rigged smooth-surface model). A vector is computed from the knuckle joint to the finger tip and this vector specifies a pointing direction. The pointing direction is used to compute a position on the display.

In some examples the click detector 510 operates 612 as described above to detect whether the user is making a selection. If the user is making a selection then information about a time of the click detection event and the pose parameter values at the time of click detection event are used to update 614 the user interface. If no click is detected the process moves to receiving the next frames of captured sensor data 600.

In some examples, when the user interface is updated 614 this comprises updating the position of a cursor on the display. In this way a user is able to self-calibrate their motion to the display. That is, the visual feedback available to the user enables the user to modify their own motion to achieve desired outcomes.

In some examples, when the user interface is updated 614 this comprises updating a graphical display in a manner such that the user is able to draw on the display as a result of their finger movements.

In some examples, when the user interface is updated 614 this comprises updating the position of a point of light or other marker on the display. For example, so that the user is able to move the point of light on the display in a manner similar to a laser pointer. In some examples, control of the point of light or other marker is passed between two or more users to enable a shared “laser pointer” functionality.

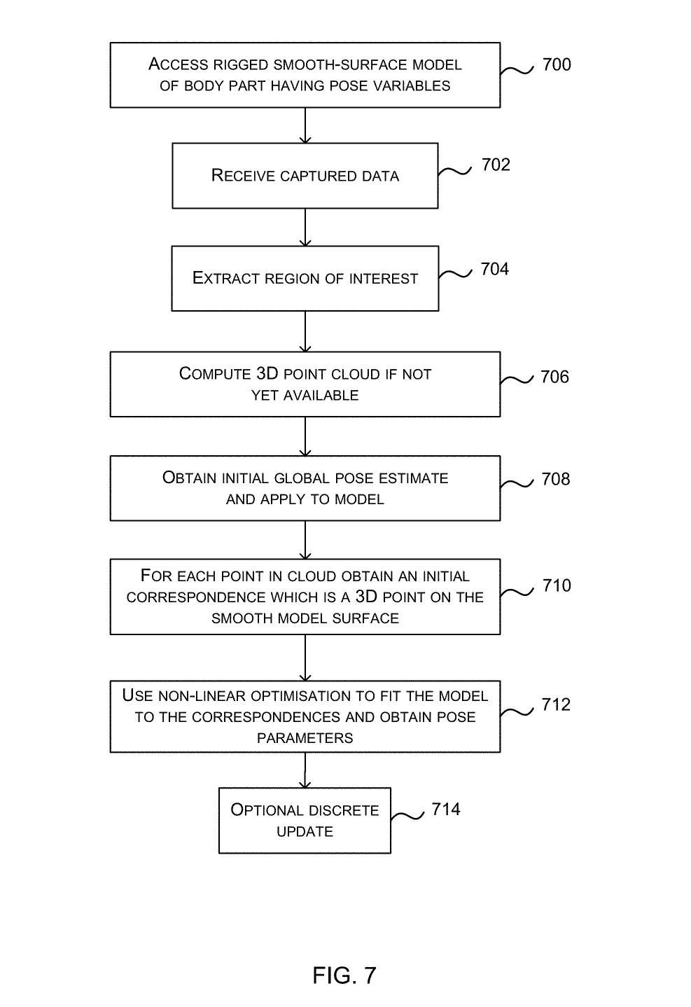

FIG. 7 is a flow diagram of a method at the tracker of FIG. 5. In this example the tracker uses a rigged-smooth surface model of a hand and is able to calculate the pose parameters in a faster and more accurate manner than previously possible. The ability to calculate pose parameters of a rigged smooth-surface model of a hand in a faster and/or more accurate manner is achieved through use of an optimization process. The optimization process fits the model to data related to captured sensor data of the object. Variables representing correspondences between the data and the model are included in the optimization jointly with the pose parameters. This enables correspondence estimation and model fitting to be unified.

A rigged model is one which has an associated representation of one or more joints of the articulated object, such as a skeleton. In various examples in this document a smooth surface model is one where the surface of the model is substantially smooth rather than having many sharp edges or discontinuities; it has isolated nearly smooth edges in some examples. In other words, a smooth surface model is one where derivatives of the surface do not change substantially anywhere on the surface. This enables a gradient based optimizer to operate as described in more detail below. A sharp edge is one in which the rate of change of surface position or orientation changes substantially from one side of the edge to another such as the corner of a room where two walls are joined at 90 degrees. A nearly smooth edge is one in which the rate of change of surface position or orientation changes suddenly but by a negligible amount, from one side of the edge to the other. For example, a mesh model is not a smooth surface model since there are generally many sharp edges where the mesh faces join.

In some examples, a smooth surface is computed from a mesh model, to obtain a smooth surface. The smooth surface is computed in some examples by repeatedly subdividing the faces of the mesh model until in the limit, a smooth surface is obtained, referred to as the limit surface. Other ways of computing a smooth surface are available. For example, closed-form solutions are optionally used to evaluate a point on the limit surface or a closely related approximation so that in practice it is not essential to subdivide the faces of the mesh model infinitely.

The tracker accesses 700 the rigged smooth-surface model of a generic hand. The tracker receives 702 captured sensor data depicting the hand to be tracked. For example, the captured data is a 3D point cloud, a depth map, one or more frames of raw time of flight data, color image data or other captured data depicting the hand to be tracked. Optionally the tracker extracts 704 a region of interest from the captured data as mentioned above.

In some examples, where the region of interest comprises parts of a depth map, the tracker computes 706 a 3D point cloud by back projecting the region of interest. In some cases a 3D point cloud is already available. In some cases no 3D point cloud is used.

Optionally the tracker obtains 708 an initial pose estimate and applies it to the model. For example, by using a value of the pose computed for a previous instance of the captured data. For example, by recording a series of values of the pose computed by the tracker and extrapolating the series to compute a predicted future value of the pose. For example, by selecting a value of the pose at random. For example, by selecting a value of the pose using output of a machine learning algorithm.

Optionally the tracker obtains 710 initial correspondence estimates. A correspondence estimate is an indication of a 3D point on the surface of the smooth-surface model corresponding to a captured data point.

In some examples a correspondence is a tuple of values denoted by the symbol u in this document, which specifies a point on the smooth-surface model. The smooth surface itself is two dimensional (2D) and so point u acts in a similar way to a 2D coordinate on that surface. A defining function S is stored at the tracker, in some examples, and is a function which takes as its input a correspondence u and the pose parameters. The defining function S computes a 3D position in the world that point u on the smooth-surface model corresponds to.

The tracker obtains 710 a plurality of initial correspondence estimates, for example, one for each point in the point cloud, or one for each of a plurality of captured sensor data points. The tracker obtains 710 the initial correspondence estimates by selecting them at random or by using machine learning, or by choosing a closest point on the model given the initial estimate of the global pose, using combinations of one or more of these approaches, or in other ways. In the case that machine learning is used a machine learning system has been trained using a large amount of training data to derive a direct transformation from image data to 3D model points.

The tracker computes an optimization 712 to fit the model to the captured data. For example, the tracker computes the following minimization beginning from the initial values of the correspondence estimates and the pose parameters where these are available (or beginning from randomly selected values)

$${min}_{θ , {u}_{1} , … {u}_{n}} {\sum }_{i = 1}^{n} ψ ( ‖ {x}_{i} - S ( {u}_{i} ; θ ) ‖ )$$

Which is expressed in words as a minimum over the pose parameters θ and n values of the correspondences u of the sum of a robust kernel ψ(•) applied to the magnitude of the difference between a 3D point cloud point xᵢ and a corresponding 3D smooth model surface point S(uᵢ;θ). Where the robust kernel ψ(•) is a Geman-McClure kernel, a Huber kernel, a Quadratic kernel or other kernel.

The optimization enables correspondence estimation and model fitting to be unified since the minimization searches over possible values of the correspondences u and over possible values of the pose parameters θ. This is unexpectedly found to give better results than an alternative approach of using alternating stages of model fitting and correspondence estimation.

The optimization is non-linear in some examples. The result of the optimization is a set of values of the pose parameters θ including the global pose parameters and the joint positions.

Because the model has a smooth surface it is possible to compute the optimization using a non-linear optimization process. For example, a gradient-based process. Jacobian optimization methods are used in some examples. This improves speed of processing. It may have been expected that such an approach (using a smooth-surfaced model and a non-linear optimization) would not work and/or would give inaccurate results. Despite this it has unexpectedly been found that this approach enables accurate results to be obtained whilst maintaining the improved speed of processing.

A discrete update operation is optionally used together with the optimization. This involves using the continuous optimization as mentioned above to update both the pose and the correspondences together, and then using a discrete update to re-set the values of the correspondences using the captured sensor data. The discrete update allows the correspondences to jump efficiently from one part of the object surface to another, for example, from one finger-tip to the next.

The process of FIG. 7 is optionally repeated, for example as new captured data arrives as part of a stream of captured data. In some examples the process of FIG. 7 is arranged to include reinitialization whereby the pose parameters used at the beginning of the optimization are obtained from another source such as a second pose estimator. For example, using global positioning sensor data, using another tracker which is independent of the tracker of FIG. 5, using random values or in other ways. Reinitialization occurs at specified time intervals, at specified intervals of instances of captured data, according to user input, according to error metrics which indicate error in the pose values or in other ways. Reinitialization using an independent tracker is found to give good results.

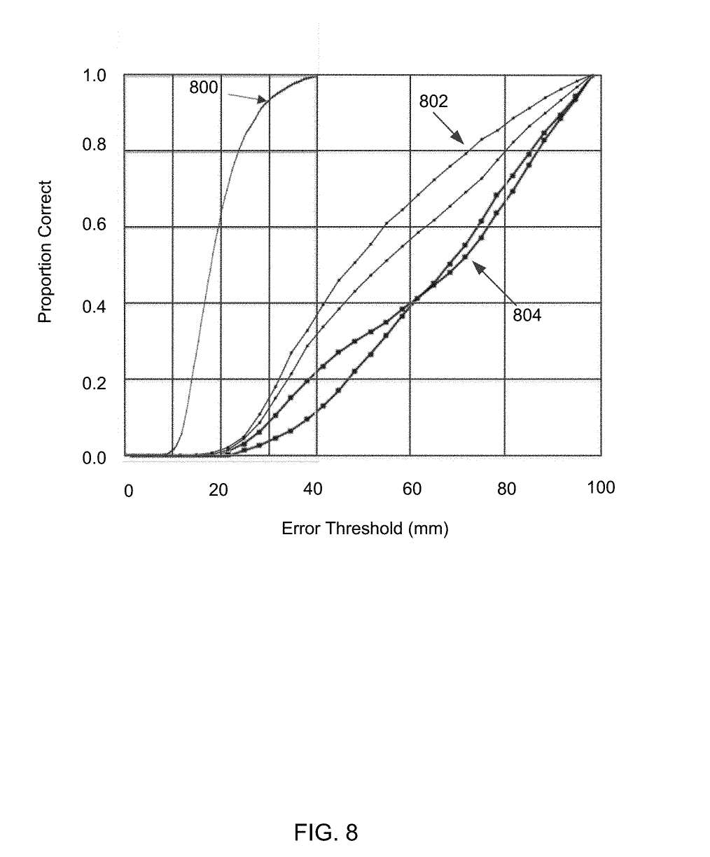

During empirical testing of a tracker using the process of FIG. 7 labeled data sets were used. For example, captured data labeled with ground truth smooth-surface model points. FIG. 8 is a graph of proportion correct against error threshold in millimeters. Proportion correct is the proportion of captured data points computed by the tracker to have corresponding model points within a certain error threshold distance (in mm) from the ground truth data. As the error threshold increases the proportion correct is expected to go up. Results for the tracker of the present technology are shown in line 800 of FIG. 8. It is seen that the results for the present technology are much more accurate than trackers with results shown in lines 802, 804 of FIG. 8 which do not unify correspondence estimation and model fitting in the same way as described herein.

As mentioned above, the tracker of the present technology computes the pose parameters with improved speed. Rendering approach trackers, using specialist graphics processing units, are found to take around 100 milliseconds (msecs) to compute pose parameters from captured data. The present technology is able to compute pose parameters from captured data in 30 msecs using a standard central processing unit (CPU). Rendering approach trackers render an image from a 3D model and compare the rendered image to captured data. This consumes large amounts of computer power, for example requiring hundreds of watts of GPU and CPU power and so is impractical for mobile devices.

FIG. 9 is a flow diagram of a method of shape calibration at a tracker such as that of FIG. 5. Shape calibration is optional in the method of FIG. 6. Where shape calibration is available the 3D model used by the tracker is calibrated to the particular shape of the user's hand by setting values of shape parameters of the model. By calibrating to the particular shape of the user's hand the tracker is able to further improve accuracy of its performance. An example method of computing values of shape parameters of the 3D model for a particular user is now given. This method is carried out at the tracker itself 506 or at another computing device in communication with the tracker over a wired or wireless link.

The tracker receives 900 the sensor data 504 and optionally extracts 902 a region of interest from the sensor data 504 as mentioned above.

The tracker accesses 904 a 3D mesh model which has shape and pose parameters. The 3D mesh model is of a generic hand and the shape and pose parameters are initially set to default values, in some examples, so that the 3D mesh model represents a neutral pose and a generic shape. In some examples the mesh model comprises a combination of an articulated skeleton and a mapping from shape parameters to mesh vertices.

In some examples the calibration engine optionally initializes the pose parameter values using values computed from a previous instance of the captured data, or from values computed from another source. However, this is not essential.

The calibration engine minimizes 306 an energy function that expresses how well data rendered from the mesh model and the received sensor data agree. The energy function is jointly optimized over the shape parameters (denoted by the symbol θ) and the pose parameters (denoted by the symbol (3) to maximize the alignment of the mesh model and the captured data. For example, the energy function may be given as follows

$${E}_{gold} ( θ , β ) = \frac{1}{WH} {\sum }_{i = 1}^{W} {\sum }_{j = 1}^{H} {{r}_{ij} ( θ , β )}^{2}$$

With the residual r_{i,j}(θ,β) for pixel (i,j) defined as a weighted difference between a captured sensor value at pixel i,j minus the value of pixel i,j in the rendered sensor data. The symbol W denotes the width in pixels of the rendered image and the symbol H denotes the height in pixels of the rendered sensor data.

In this example, the energy function is expressed in words as:

an energy over pose parameters and shape parameters of a 3D mesh model of an articulated object is equal to an average of the sum of squared differences between captured sensor data points and corresponding data points rendered from the model.

However, it is not straightforward to optimize an energy function of this form because the energy function is not smooth and contains discontinuities in its derivatives. Also, it is not apparent that optimizing this form of energy function would give workable calibration results. It is found in practice that the above energy function is only piecewise continuous as moving occlusion boundaries cause jumps in the value of rendered data points.

Unexpectedly good results are found where the calibration engine is configured to compute the optimization process by using information from derivatives of the energy function. In some examples, the optimization process is done using a gradient-based optimizer such as the Levenberg-Marquardt optimizer, gradient descent methods, the conjugate gradient method and others. A gradient-based optimizer is one which searches an energy function using search directions that are defined using the gradient of the function at the current point. Gradient-based optimizers require the derivatives of the energy function, and some require the use of Jacobian matrices to represent these derivatives for parts of the energy function. A Jacobian matrix is a matrix of all first-order partial derivatives of a vector valued function.

The calibration engine is configured to compute the optimization process using finite differences in some examples. Finite differences are discretization methods for computing derivatives by approximating them with difference equations. In difference equations, finite differences approximate the derivatives.

In some examples the calibration engine is configured to use a differentiable renderer. That is, the derivatives of the energy function which are to be computed to search for a minimum of the energy function, are computed using a renderer of a graphics processing unit as described in more detail below. This contributes to enabling minimization of the energy function in practical time scales.

In some examples the energy function includes a pose prior energy. The pose prior energy is a term in the energy function which provides constraints on the values of the pose parameters. For example, to avoid unnatural and/or impossible poses from being computed. It is found that use of a pose prior is beneficial where there are occlusions in the captured data. For example, in self-occluded poses during hand tracking where the fingers or forearm are not visible in the rendered image.

In some examples the calibration engine is configured to minimize the energy function where the energy function includes a sum of squared differences penalty. It has been found that using a sum of squared differences penalty (also referred to as an L2 penalty) gives improved results as compared with using a L1 penalty where an L1 penalty is a sum of absolute differences.

In various examples the mesh model includes information about adjacency of mesh faces. However, this is not essential. In some examples the mesh model does not have information about adjacency of mesh faces.

Once the calibration engine has computed the values of the shape parameters it sends 908 those to the tracker.

The tracker receives the shape parameters and applies them to the rigged 3D mesh model and/or the related smooth-surface model. The tracker then proceeds to fit captured sensor data (504 of FIG. 5), to the calibrated rigged model.

Calibration occurs in an online mode or in an offline mode or hybrids of these. In the online mode tracking is ongoing whilst the calibration takes place. In the offline mode tracking is not occurring whilst the calibration takes place.

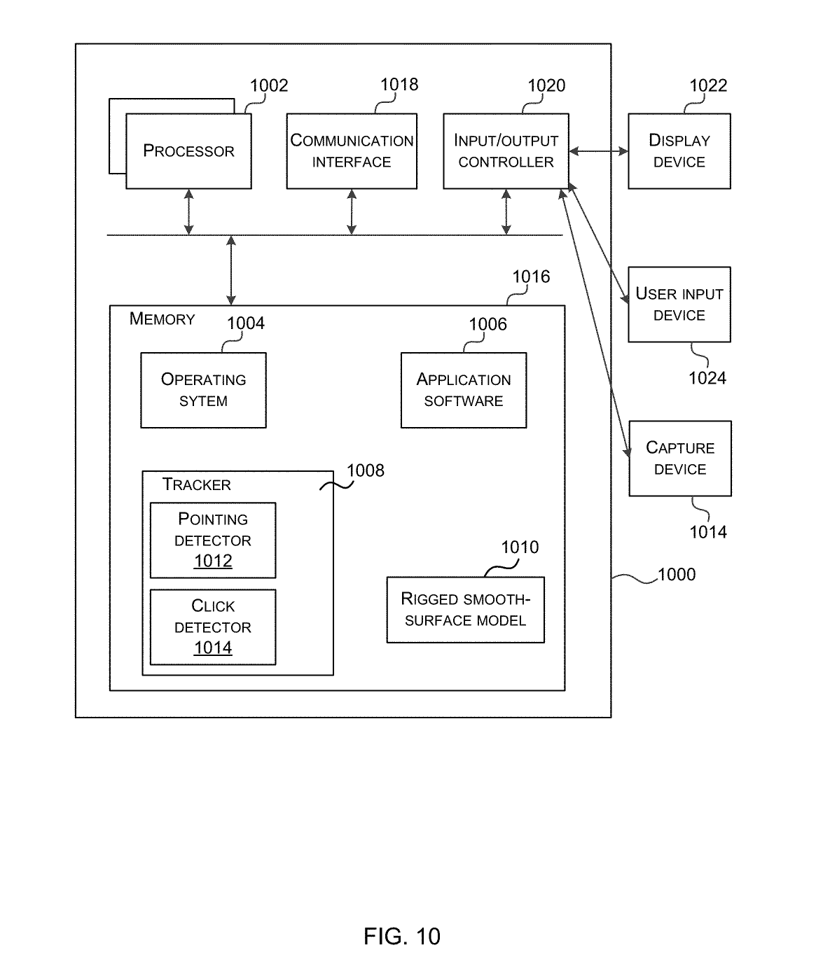

FIG. 10 illustrates various components of an exemplary computing-based device 1000 which is implemented as any form of a computing and/or electronic device, and in which embodiments of a tracker and touch-less user interface may be implemented.

Computing-based device 1000 comprises one or more processors 1002 which are microprocessors, controllers or any other suitable type of processors for processing computer executable instructions to control the operation of the device in order to track hands of users, track objects and surfaces in the environment, and to compute data for updating a touch-less user interface. In some examples, for example where a system on a chip architecture is used, the processors 1002 include one or more fixed function blocks (also referred to as accelerators) which implement a part of the method of tracking hands, surfaces and objects and updating a user interface in hardware (rather than software or firmware) in some examples. Platform software comprising an operating system 1004 or any other suitable platform software is provided at the computing-based device to enable application software 1006 to be executed on the device. In some examples, software comprising a tracker 1008 is provided at the computing-based device where the tracker 1008 comprises a pointing detector 1012 and a click detector 1014. Where the tracker uses a rigged smooth-surface model 1010 this is stored at the computing-based device 1000.

The computer executable instructions are provided using any computer-readable media that is accessible by computing based device 1000. Computer-readable media include, for example, computer storage media such as memory 1016 and communications media. Computer storage media, such as memory 1016, includes volatile and non-volatile, removable and non-removable media implemented in any method or technology for storage of information such as computer readable instructions, data structures, program modules or the like. Computer storage media includes, but is not limited to, random access memory (RAM), read-only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is usable to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1016) is shown within the computing-based device 1000 it will be appreciated that the storage are optionally distributed or located remotely and accessed via a network or other communication link (e.g. using communication interface 1018).

The computing-based device 1000 also comprises an input/output controller 1020 arranged to output display information to a display device 1022 which is separate from or integral to the computing-based device 1000. The display information provides a graphical user interface as part of the touch-less user interface. In some examples, the input/output controller 1020 is also arranged to receive and process input from one or more devices, such as a user input device 1024 (e.g. a mouse, keyboard, camera, microphone or other sensor). That is, the user interface operates as a touch-less user interface in addition to operation in other manners in some examples. In some examples the user input device 1024 detects voice input, user gestures or other user actions. In an embodiment the display device 1022 may also act as the user input device 1024 if it is a touch sensitive display device. The input/output controller 1020 outputs data to devices other than the display device, e.g. a locally connected printing device in some examples.

Any of the input/output controller 1020, display device 1022 and the user input device 1024 optionally comprise technology which enables a user to interact with the computing-based device in a variety of different modalities beyond mouse and keyboard, remote controls and the like. Examples of technology that are optionally provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence.

In some examples, the computing-based device includes technology implementing intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (electro encephalogram (EEG) and related methods).

Alternatively or in addition to the other examples described herein, examples include any combination of the following:

In an example there is a computer-implemented method comprising:

means for rendering graphical data on a display;

means for receiving captured sensor data depicting at least one hand of a user operating a user interface without touching the user interface;

means for computing, from the captured sensor data, values of pose parameters of a three dimensional model of the hand, the pose parameters comprising position and orientation of each of a plurality of joints of the hand;

means for computing, at a processor, at least one position on the display from the pose parameters; and

means for updating the rendered graphical data on the basis of the position.

For example, the means for rendering is a display controller, the means for receiving is a memory, and the means for computing is a processor.

The examples illustrated and described herein as well as examples not specifically described herein but within the scope of aspects of the disclosure constitute exemplary means for user interface operation at-a-distance through hand tracking. For example, the elements illustrated in FIG. 5, such as when encoded to perform the operations illustrated in any of FIGS. 6, 7 and 9, constitute exemplary means for rendering graphical data on a display, exemplary means for receiving captured sensor data, exemplary means for computing values of pose parameters and at least one position on a display, and exemplary means for updating the rendered graphical data.

In an example there is a user interface comprising:

a display controller configured to render graphical data on a display;

a memory configured to receive captured sensor data depicting at least one hand of a user operating the user interface without touching the user interface;

a tracker configured to compute, from the captured sensor data, values of pose parameters of a three dimensional model of the hand, the pose parameters comprising position and orientation of each of a plurality of joints of the hand;

a processor configured to compute at least one position on the display from the pose parameters;

the processor configured to update the graphical data on the basis of the position.

For example, there is a mapping between the pose parameters and the position on the display.

In some examples there is no direct correspondence between the pose parameters and the position on the display.

In examples, the processor computes the position on the display according hand-relative input, by taking into account position and orientation of a digit relative to the hand.

In examples, the processor computes the position on the display according to relative velocity input by using position and orientation of a digit relative to the hand to define the velocity of a cursor on the display.

In examples the processor computes the position on the display according to relative position input by using the position of a digit relative to another object to control position of a cursor on the display.

In examples, the processor is configured to compute at least two positions on the display from the pose parameters, each position being related to a different digit of the hand.

In examples, the captured sensor data depicts a surface in an environment of the user, the tracker is configured to track the position of the surface, and where the processor is configured to compute the position on the display on the basis of the tracked position of the surface in addition to the pose parameters.

In examples, the processor is configured to compute the position on the display from the pose parameters of an individual finger without the need to track whole hand movements.

In examples, the processor is configured to update the display of a cursor or other marker on the display on the basis of the position.

In examples, the processor is configured to update the display using the position as for a mouse-based or touch-based user interface.

In examples, the memory is configured to receive the captured sensor data depicting a plurality of hands, of the same or different users, where the tracker is configured to compute pose parameters of each of the hands, and where the processor is configured to update the display on the basis of the pose parameters of each of the hands.

In examples, the processor is configured to determine whether the user is pointing or not, on the basis of the pose parameters.

In examples, the processor is configured to determine whether the user is clicking or not, on the basis of the pose parameters.

In examples, the processor is configure to compute, from the pose parameters, a vector from a knuckle to a fingertip, and to determine a pointing direction from the vector.

In examples, the processor is configured to compute values of the pose parameters by calculating an optimization to fit the model to data related to the captured sensor data, where variables representing correspondences between the data and the model are included in the optimization jointly with the pose parameters.

In examples, the tracker is configured such that the model is a rigged, smooth-surface model of the hand.

In examples, the tracker is configured such that the model has shape parameters calibrated to the user's hand.

In an example there is a user interface comprising:

a display controller configured to render graphical data on a display;

a memory configured to receive captured sensor data depicting at least one hand of a user operating the user interface without touching the user interface;

a tracker configured to compute, from the captured sensor data, values of pose parameters of a three dimensional model calibrated to shape of the user's hand, the pose parameters comprising position and orientation of each of a plurality of joints of the hand;

a processor configured to compute at least one position on the display from the pose parameters and to update the graphical data on the basis of the position.

In examples there is a computer-implemented method comprising:

rendering graphical data on a display;

receiving captured sensor data depicting at least one hand of a user operating a user interface without touching the user interface;

computing, from the captured sensor data, values of pose parameters of a three dimensional model of the hand, the pose parameters comprising position and orientation of each of a plurality of joints of the hand;

computing, at a processor, at least one position on the display from the pose parameters; and

updating the rendered graphical data on the basis of the position.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants and many other devices.

The methods described herein are optionally performed by software in machine readable form on a tangible storage medium e.g. in the form of a computer program comprising computer program code means adapted to perform all the operations of any of the methods described herein when the program is run on a computer and where the computer program is embodied on a computer readable medium. Examples of tangible storage media include computer storage devices comprising computer-readable media such as disks, thumb drives, memory etc. and do not include propagated signals. The software is suitable for execution on a parallel processor or a serial processor such that the method operations are carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer is able to download pieces of the software as needed, or execute some software instructions at the local terminal and some at the remote computer (or computer network). Those skilled in the art will also realize that by utilizing conventional techniques known to those skilled in the art that all, or a portion of the software instructions are optionally carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above relate to one embodiment or relate to several embodiments. The embodiments are not limited to those that solve any or all of the stated problems or those that have any or all of the stated benefits and advantages. It will further be understood that reference to ‘an’ item refers to one or more of those items.

The operations of the methods described herein are carried out in any suitable order, or simultaneously where appropriate. Additionally, individual blocks may be deleted from any of the methods without departing from the spirit and scope of the subject matter described herein. Aspects of any of the examples described above are optionally combined with aspects of any of the other examples described to form further examples without losing the effect sought.

The term ‘comprising’ is used herein to mean including the method blocks or elements identified, but that such blocks or elements do not comprise an exclusive list and a method or apparatus is able to contain additional blocks or elements.

It will be understood that the above description is given by way of example only and that various modifications are optionally made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A user interface comprising:
a display controller configured to render graphical data on a display;
a memory configured to receive captured sensor data depicting at least one hand of a user operating the user interface without touching the user interface;
a tracker configured to compute, from the captured sensor data, values of pose parameters of a three dimensional model of the hand, the pose parameters comprising position and orientation of each of a plurality of joints of the hand; and
a processor configured to compute at least one position on the display from the pose parameters;
the processor configured to update the graphical data on the basis of the position.

2. The user interface of claim 1 wherein there is a mapping between the pose parameters and the position on the display.

3. The user interface of claim 1 wherein there is no direct correspondence between the pose parameters and the position on the display.

4. The user interface of claim 3 wherein the processor computes the position on the display according hand-relative input, by taking into account position and orientation of a digit relative to the hand.

5. The user interface of claim 3 wherein the processor computes the position on the display according to relative velocity input by using position and orientation of a digit relative to the hand to define the velocity of a cursor on the display.

6. The user interface of claim 3 wherein the processor computes the position on the display according to relative position input by using the position of a digit relative to another object to control position of a cursor on the display.

7. The user interface of claim 1 wherein the processor is configured to compute at least two positions on the display from the pose parameters, each position being related to a different digit of the hand.

8. The user interface of claim 1 wherein the captured sensor data depicts a surface in an environment of the user, the tracker is configured to track the position of the surface, and where the processor is configured to compute the position on the display on the basis of the tracked position of the surface in addition to the pose parameters.

9. The user interface of claim 1 wherein the processor is configured to compute the position on the display from the pose parameters of an individual finger without the need to track whole hand movements.

10. The user interface of claim 1 wherein the processor is configured to update the display of a cursor or other marker on the display on the basis of the position.

11. The user interface of claim 1 wherein the processor is configured to update the display using the position as for a mouse-based or touch-based user interface.

12. The user interface of claim 1 wherein the memory is configured to receive the captured sensor data depicting a plurality of hands, of the same or different users, where the tracker is configured to compute pose parameters of each of the hands, and where the processor is configured to update the display on the basis of the pose parameters of each of the hands.

13. The user interface of claim 1 where the processor is configured to determine whether the user is pointing or not, on the basis of the pose parameters.

14. The user interface of claim 1 where the processor is configured to determine whether the user is clicking or not, on the basis of the pose parameters.

15. The user interface of claim 13 wherein the processor is configure to compute, from the pose parameters, a vector from a knuckle to a fingertip, and to determine a pointing direction from the vector.

16. The user interface of claim 1 where the processor is configured to compute values of the pose parameters by calculating an optimization to fit the model to data related to the captured sensor data, where variables representing correspondences between the data and the model are included in the optimization jointly with the pose parameters.

17. The user interface of claim 16 where the tracker is configured such that the model is a rigged, smooth-surface model of the hand.

18. The user interface of claim 1 wherein the tracker is configured such that the model has shape parameters calibrated to the user's hand.

19. A user interface comprising:
a display controller configured to render graphical data on a display;
a memory configured to receive captured sensor data depicting at least one hand of a user operating the user interface without touching the user interface;
a tracker configured to compute, from the captured sensor data, values of pose parameters of a three dimensional model calibrated to shape of the user's hand, the pose parameters comprising position and orientation of each of a plurality of joints of the hand; and
a processor configured to compute at least one position on the display from the pose parameters and to update the graphical data on the basis of the position.

20. A computer-implemented method comprising:
rendering graphical data on a display;
receiving captured sensor data depicting at least one hand of a user operating a user interface without touching the user interface;
computing, from the captured sensor data, values of pose parameters of a three dimensional model of the hand, the pose parameters comprising position and orientation of each of a plurality of joints of the hand;
computing, at a processor, at least one position on the display from the pose parameters; and
updating the rendered graphical data on the basis of the position.
